(19) United States
(12) Patent Application Publication
(10) Pub. No.: US 2026/0293990 A1
(43) Pub. Date: Oct. 1, 2026

(54) AEROSOL-GENERATING SYSTEM COMPRISING AN INDUCTOR COIL FOR INDUCTIVE AND RESISTIVE HEATING

(71) Applicant: Philip Morris Products S.A., Neuchatel (CH)

(72) Inventors: Oleg MIRONOV, Cudrefin (CH); Johannes Petrus Maria PIJNENBURG, Neuchâtel (CH); Enrico STURA, Palézieux-Village (CH); Julien VIDAL, Peseux (CH)

(73) Assignee: Philip Morris Products S.A., Neuchatel (CH)

(21) Appl. No.: 19/479,381

(22) PCT Filed: Apr. 25, 2024
(86) PCT No.: PCT/EP2024/061443

§ 371 Date: Oct. 28, 2025

(30) Foreign Application Priority Data
May 2, 2023 (EP) 23171160.7

(51) Int. Cl. A24F 40/465; A24F 40/20; A24F 40/57; H05B 6/10

(52) U.S. Cl. CPC A24F 40/465; A24F 40/57; H05B 6/10; A24F 40/20

(57) ABSTRACT

An aerosol-generating system for generating an aerosol from an aerosol-forming substrate of an aerosol-generating article is provided, including: control electronics; and an electric heating arrangement including an inductor coil and a susceptor, the susceptor positioned at least partially within the coil; the control electronics being configured to: supply electric energy to the inductor coil as an alternating current such that the arrangement is operable to generate heat through resistance heating of the coil and/or heating of the susceptor through inductive coupling of the coil with the susceptor, and apply the current to the coil over successive first and second phases of operation and adjust a frequency of the current to change inductive coupling of the coil with the susceptor between the phases, thereby adjusting a balance of heat generated through the inductive coupling of the coil with the susceptor relative to heat generated through resistance heating of the coil.

The present disclosure relates to an aerosol-generating system for generating an aerosol from an aerosol-forming substrate and a method of heating an aerosol-forming substrate of an aerosol-generating article.

It is known to evolve an aerosol from an aerosol-forming substrate of an aerosol-generating article by the application of heat to the substrate, so as to avoid burning or combustion of the substrate. It is known to externally apply heat to such an aerosol-generating article to heat the aerosol-forming substrate of the article. Typically, the aerosol-generating article includes a wrapper circumferentially enclosing the aerosol-forming substrate. The wrapper impedes the transfer of heat from outside of the aerosol-generating article to the aerosol-forming substrate, which can result in insufficient heating of the substrate and a poor user experience. Although additional heat can be applied to overcome the effect of the wrapper in impeding heat flow, the aerosol-forming substrate may be heated in a non-uniform manner. More specifically, the heating of the aerosol-forming substrate will be greatest at or adjacent to the wrapper and reduce with increasing distance away from the wrapper into the substrate. It is also known to heat the aerosol-forming substrate of such an article from within the substrate, by use of a heating element located within the interior of the aerosol-forming substrate. Internally heating the aerosol-forming substrate avoids heat having to traverse through the wrapper to reach the aerosol-forming substrate. However, internally heating the aerosol-forming substrate may still result in the aerosol-forming substrate being heated in a non-uniform manner, with heating of the substrate being greatest at or adjacent to the internal heating element and reducing with increasing distance away from the internal heating element into the substrate. Non-uniform heating of the aerosol-forming substrate can result in the substrate being only partially depleted at the completion of a usage session. Increasing the level of heat applied to the substrate in order to fully deplete the aerosol-forming substrate when using either external heating or internal heating of the substrate may result in unintended and undesired burning of the substrate.

It is therefore desired to heat an aerosol-forming substrate so as to provide for improved depletion of the aerosol-forming substrate, without burning or combustion of the substrate.

According to a first aspect of the present disclosure, there is provided an aerosol-generating system for generating an aerosol from an aerosol-forming substrate of an aerosol-generating article. The aerosol-generating system may comprise control electronics and an electric heating arrangement. The electric heating arrangement may comprise an inductor coil and a susceptor, the susceptor positioned or positionable such that the susceptor is at least partially within the inductor coil. The control electronics may be configured to supply electric energy from a power source to the inductor coil as an alternating current such that the electric heating arrangement is operable to generate heat through one or a combination of i) resistance heating of the inductor coil and ii) heating of the susceptor through inductive coupling of the inductor coil with the susceptor. The control electronics may be configured to adjust at least one parameter of the alternating current so as to change the inductive coupling of the inductor coil with the susceptor, thereby adjusting the balance of heat generated through inductive coupling of the inductor coil with the susceptor relative to heat generated through resistance heating of the inductor coil.

In this manner, the heating arrangement may be able to change the mode of application of heat to the aerosol-forming substate to any one of the following heating regimes: a) solely or predominantly through the resistance heating of the inductor coil; b) solely or predominantly through heating of the susceptor through the inductive coupling of the inductor coil with the susceptor; c) a combination of resistance heating of the inductor coil and heating of the susceptor through the inductive coupling of the inductor coil with the susceptor.

Adjusting the balance of heat generated through inductive coupling of the inductor coil with the susceptor relative to heat generated through resistance heating of the inductor coil may facilitate more uniform heating of the aerosol-forming substrate and may provide for improved depletion of the substrate.

Using a single inductor coil to provide both heating power to an internal susceptor and resistance heating of the coil itself provides two different heat sources in different locations relative to the aerosol-forming substrate, with a structure that is no more complex than a typical induction heating arrangement.

Preferably, the at least one parameter comprises a frequency of the alternating current. The inductive coupling between the inductor coil and susceptor varies with changes in the frequency of the alternating current. The frequency may be adjusted to have a value f_{susceptor}, associated with an alternating current creating a varying magnetic field that best couples with the susceptor so as to allow transfer of almost the totality of the energy in the current to the susceptor, resulting in most of the heat being generated by heating of the susceptor. The frequency may also be adjusted to have a value f_{inductor coil}, associated with an alternating current creating a magnetic field that provides little to no coupling with the susceptor and allows almost the totality of the energy to remain within the inductor coil, resulting in most of the heat being generated by resistance heating of the inductor coil. The frequency may also be adjusted to have a value fₜₒₜₐₗ, associated with an alternating current which results in a combination of heating of the susceptor and resistance heating of the inductor coil. Each of these frequencies will vary depending on the materials, physical properties and configuration of the inductor and susceptor, such as the inductance of the inductor coil and magnetic permeability of the material(s) employed for the susceptor.

The control electronics may be configured to adjust the frequency of the alternating current from a first frequency value or range of values to a second frequency value or range of values. The first frequency value or range of values may correspond to a first heating state of the electric heating arrangement and the second frequency value or range of values correspond to a second heating state of the electric heating arrangement. Preferably, the second frequency value or range of values is closer than the first frequency value or range of values to a resonant frequency of the electric heating arrangement, such that the inductive coupling of the inductor coil with the susceptor is increased in the second heating state compared to the first heating state.

Advantageously, the control electronics may be configured to trigger adjustment of the frequency of the alternating current between the first and second values or range of values as a function of one or more of: a) a puff count over a usage session; b) time elapsed since commencement of a usage session; c) detection of a puff in a usage session. The system may detect the application of a puff by use of a pressure sensor or a temperature sensor. The heating arrangement may itself function as a means of determining temperature, or of detecting or determining changes in temperature.

The control electronics may be configured to adjust the frequency of the alternating current from the first frequency value or range of values to the second frequency value or range of values in response to receiving a signal indicative of a puff being applied to the aerosol-generating system. The control electronics may be configured to maintain the frequency of the alternating current at the second frequency value or range of values for a predetermined period of time after receiving the signal indicative of a puff being applied to the aerosol-generating system. The predetermined period of time may equate to or exceed a duration of the applied puff.

The control electronics may be configured to, after elapse of the predetermined period of time, adjust the frequency of the alternating current from the second frequency value or range of values to a third frequency value or range of values. The third frequency value or range of values corresponds to a third heating state of the electric heating arrangement. The third frequency value or range of values is farther away than the second frequency value or range of values from the resonant frequency of the electric heating arrangement, such that the inductive coupling of the inductor coil with the susceptor is reduced in the third heating state compared to the second heating state. Each of the first, second and third heating states may be different to each other; for example, each heating state may be associated with a different level of heating generated by the heating arrangement. Each of the first, second and third heating states may be associated with different corresponding target operating temperatures for the aerosol-forming substrate.

The resonant frequency may be determined according to the following equation:

$${f}_{R} = \frac{1}{2 π \sqrt{L C}}$$

in which f_{R} is the resonant frequency, L is an inductance of the electric heating arrangement and C is a capacitance of the electric heating arrangement.

The parameter of the alternating current may alternatively or additionally comprise a magnitude of the alternating current. Increasing or decreasing the magnitude of the alternating current to the inductor coil will result in a corresponding increase or decrease in the strength of the magnetic field generated about the inductor coil, and increase or decrease the level of heating of the inductor coil and/or of the susceptor. The balance of heat generated by heating of the inductor coil (through resistance heating thereof) and heating of the susceptor (through inductive coupling of the inductor coil with the susceptor) will vary with changes in frequency of the alternating current.

Advantageously, the control electronics may also be configured to supply electric energy from a power source to the inductor coil as a direct current. Supplying direct current to the inductor coil will not result in a varying magnetic field about the inductor coil and therefore not produce heating of the susceptor. Rather, any heating effect due to the supply of direct current will be confined to resistance heating of the inductor coil.

In a similar manner to the control of the supply of alternating current described above, the control electronics may be configured to activate or adjust the supply of direct current to the inductor coil as a function of one or more of a) a puff count over a usage session; b) time elapsed since commencement of a usage session; and c) detection of a puff in a usage session. As noted above, the system may be configured to detect the application of a puff by use of a pressure sensor or a temperature sensor. The heating arrangement may itself function as a means of determining temperature, or of detecting or determining changes in temperature. The control electronics may be configured to activate or increase the supply of direct current to the inductor coil in response to the control electronics receiving a signal indicative of a puff being applied to the aerosol-generating system.

The control electronics may be configured to provide alternating current and direct current to the inductor coil in an alternating sequence. It may be beneficial to alternate external and internal heating in order to avoid overheating of any part of the aerosol-forming substrate.

The control electronics may be configured to provide both alternating current and direct current to the inductor coil concurrently. In this way a larger amount of heat energy can be transferred to the aerosol-forming substrate to generate a larger volume of aerosol, without either the susceptor or coil reaching a temperature at which any part of the aerosol-generating article might combust.

Conveniently, the control electronics may be configured to switch between one or more of the following operational states: a) a first operational state in which the inductor coil is supplied with alternating current alone; b) a second operational state in which the inductor coil is supplied with direct current alone; and c) a third operational state in which the inductor coil is supplied with both alternating current and direct current.

Each of the first, second and third operational states may be associated with different corresponding levels of heating generated by the heating arrangement. Each of the first, second and third operational states may be associated with different corresponding target operating temperatures for the aerosol-forming substrate.

Preferably, the control electronics may be configured to select between different ones of the first, second and third operational states as a function of one or more of: a) a puff count over a usage session; b) time elapsed since commencement of a usage session; and c) detection of a puff in a usage session.

Again, as noted above, the system may be configured to detect the application of a puff by use of a pressure sensor or a temperature sensor. The heating arrangement may itself function as a means of determining temperature, or of detecting or determining changes in temperature.

The aerosol-generating system may comprise an aerosol-generating device. The aerosol-generating device may comprise the inductor coil, the susceptor and a chamber. The inductor coil may surround or at least partially define a peripheral wall of the chamber. The susceptor may be arranged within the chamber. The chamber may be configured to receive an aerosol-generating article comprising an aerosol-forming substrate such that the susceptor inserts within the aerosol-generating article.

The susceptor may extend from a base of the chamber along a longitudinal axis of the chamber.

The aerosol-generating system may further comprise the aerosol-generating article, wherein one or both of the aerosol-generating device and the aerosol-generating article are configured such that, on the aerosol-generating article being received in the chamber, the susceptor is enclosed by or at least partially embedded within the aerosol-forming substrate of the aerosol-generating article.

Conveniently, the susceptor may form all or part of a pin or blade configured to penetrate the aerosol-forming article when the aerosol-forming article is received in the chamber.

Alternatively, the aerosol-generating system may comprise an aerosol-generating device and an aerosol-generating article, in which the susceptor forms part of the aerosol-generating article (rather than the aerosol-generating device). The aerosol-generating device may comprise the inductor coil and a chamber. The inductor coil may surround or at least partially define a peripheral wall of the chamber. The aerosol-generating article may comprise an aerosol-forming substrate and the susceptor, the susceptor enclosed by or at least partially embedded within the aerosol-forming substrate. The chamber may be configured to receive the aerosol-generating article such that the susceptor is positioned at least partially within the inductor coil.

The inductor coil may be suspended inside the chamber. This reduces heat losses from the coil to a housing of the aerosol-generating device in which the chamber is defined and so improves the efficiency of the device. The inductor coil may be a helical coil. The helical coil may comprise a first end and a second end. The housing may contact the inductor coil only at the first end and the second end of the inductor coil.

The housing may comprise an inner surface at least partially defining the chamber. Each of the first end of the inductor coil and the second end of the inductor coil may abut the inner surface of the housing. The inner surface of the housing may define a first recess and a second recess, wherein the first end of the inductor coil is positioned within the first recess and wherein the second end of the inductor coil is positioned within the second recess.

The inner surface of the housing may define a first slot and a second slot, wherein the first end of the inductor coil extends through the first slot and wherein the second end of the inductor coil extends through the second slot. An outer surface of the inductor coil may be spaced apart from the inner surface of the housing.

The chamber may comprise an open first end through which at least a portion of an aerosol-generating article may be inserted into the chamber and a closed second end opposite the open first end.

The aerosol-generating device may further comprise an airflow channel defined between the inner surface of the housing and the outer surface of the inductor coil, wherein the airflow channel provides fluid communication between the first end of the chamber and the second end of the chamber.

The aerosol-generating device may further comprise at least one protrusion extending into the chamber from the closed second end of the chamber. The housing may comprise an end wall defining the closed second end of the chamber. The at least one protrusion may extend into the chamber from the end wall. The at least one protrusion may be formed integrally with the end wall. The at least one protrusion may comprise at least three protrusions. The chamber may have a longitudinal axis defining a first direction along which at least a portion of an aerosol-generating article may be inserted into the chamber. The at least three protrusions may be equidistantly spaced from each other in a circumferential direction around the longitudinal axis.

The inductor coil may be configured to be in surface contact with an exterior surface of the aerosol-generating article upon the aerosol-generating article being received in the chamber. Surface contact between the inductor coil and the exterior surface of the aerosol-generating article may facilitate the conduction of heat generated by resistance heating of the inductor coil to the aerosol-generating article. Surface contact between the inductor coil and the exterior surface of the aerosol-generating article may also facilitate retaining the aerosol-generating article in a desired position within the chamber of the aerosol-generating device relative to the inductor coil.

The inductor coil may comprise a flat spiral inductor coil. The inductor coil may have a tubular shape or a helical shape. Preferably, the inductor coil is both tubular and helical. Preferably, the tubular and helical coil has a non-circular cross section, when viewed in a direction perpendicular to the longitudinal length direction of the coil, i.e. in a direction perpendicular to the magnetic centre-axis of the coil. Where the inductor coil is intended to be in surface contact with an exterior surface of the aerosol-generating article, the use of a coil having a flat cross-sectional profile may facilitate conduction between the coil and the article of heat generated by resistive heating of the coil.

The inductor coil may be formed in an electrically conductive tubular member, with one or more cut-outs provided in the tubular member to thereby define the shape and configuration of the inductor coil.

The inductor coil may be formed from a coiled wire. The coiled wire may comprise an electrically conductive core and a coating on the electrically conductive core. The coating may be electrically insulating. The coating may comprise at least one of a polymer, a ceramic, and a glass.

The inductor coil may comprise a metal. The metal may comprise copper or stainless steel.

The inductor coil may comprise: a first tubular portion of electrically conductive material; a second tubular portion of electrically conductive material; and a helical coil of electrically conductive material extending between the first tubular portion of electrically conductive material and the second tubular portion of electrically conductive material.

The helical coil may be formed integrally with the first tubular portion and the second tubular portion. Preferably, each of the first tubular portion, the second tubular portion, and each turn of the helical coil has a maximum width extending in a direction parallel to a longitudinal axis of the inductor coil, wherein the maximum width of each of the first tubular portion and the second tubular portion is greater than the maximum width of each turn of the helical coil.

The inductor coil may comprise a plurality of discrete apertures in at least one of the first tubular portion of electrically conductive material and the second tubular portion of electrically conductive material. The plurality of discrete apertures may be present in both the first tubular portion of electrically conductive material and the second tubular portion of electrically conductive material. The plurality of discrete apertures may be distributed symmetrically in a circumferential direction extending around a longitudinal axis of the inductor coil. Each of the discrete apertures may have a circular shape, a triangular shape, a rectangular shape, a pentagonal shape, a hexagonal shape, a heptagonal shape, or an octagonal shape.

The inductor coil may further comprise a layer of electrically insulating material extending around an outer surface of the first tubular portion, the second tubular portion and the helical coil. The layer of electrically insulating material may comprise a strip of the electrically insulating material extending around the outer surface of the first tubular portion, the second tubular portion and the helical coil. The strip of electrically insulating material may extend in a helical shape around the outer surface of the first tubular portion, the second tubular portion and the helical coil. The helical strip of electrically insulating material may be wound in a first direction, wherein the helical coil turns in a second direction, and wherein the second direction is opposite to the first direction. The layer of electrically insulating material may be overmoulded on the outer surface of the first tubular portion, the second tubular portion and the helical coil.

The helical coil of electrically conductive material may have an inner surface, and at least one edge of the turns of the helical coil may comprises a bevel, a chamfer or a fillet.

The inductor coil may comprise a core layer comprising a material of a first electrical resistivity and an outer layer comprising a material of a second electrical resistivity, wherein the first electrical resistivity is higher than the second electrical resistivity. Heat generated by the direct current in the coil is generated primarily in the core layer. The alternating current is conducted primarily in the outer layer, and generates little heat as a result of Joule heating.

The aerosol-generating system may further comprise a thermally conductive bridging element configured to extend between the inductor coil and an exterior surface of the aerosol-generating article when the article is received in the chamber of the aerosol-generating device. The thermally conductive bridging element may comprise a sleeve disposed radially inward of the inductor coil. The sleeve may at least partially define a peripheral wall of the chamber. The thermally conductive bridging element permits heat to be conducted from the inductor coil to the aerosol-generating article whilst avoiding direct contact between the inductor coil and the exterior surface of the aerosol-generating article. So, the provision of the thermally conductive bridging element may reduce the likelihood of damage to the inductor coil on insertion or removal of the article from the chamber.

At least one of the control electronics and the thermally conductive bridging element may be configured to prevent inductive coupling between the thermally conductive bridging element and the inductor coil during use.

The control electronics may be configured to provide the alternating current with a frequency selected to prevent inductive coupling between the thermally conductive bridging element and the inductor coil during use.

The thermally conductive bridging element may be formed from a non-electrically conductive material. The thermally conductive bridging element may be formed from a non-inductively heatable material. The thermally conductive bridging element may comprise at least one of a polymeric material and a metal. The thermally conductive bridging element may comprise at least one of aluminium and a paramagnetic steel. The paramagnetic steel may comprise an austenitic steel. The thermally conductive bridging element may comprise a polymeric material and at least one of graphite, a graphite-derived material, and hexagonal boron nitride dispersed within the polymeric material. The polymeric material may comprise at least one of polyether ether ketone (PEEK) and a liquid crystal polymer (LCP). The thermally conductive bridging element may comprise the polymeric material in an amount of between 22 percent and 33 percent by weight of the thermally conductive bridging element. The graphite-derived material may comprise at least one of expanded graphite and graphite nanoplatelets. The thermally conductive bridging element may comprise at least one of graphite, a graphite-derived material, and hexagonal boron nitride in an amount of between 62 percent and 69 percent by weight of the thermally conductive bridging element. The thermally conductive bridging element may further comprise at least one additive dispersed within the polymeric material. The at least one additive may comprise carbon black. The thermally conductive bridging element may comprise the at least one additive in an amount of between 5 percent and 9 percent by weight of the thermally conductive bridging element.

The power source and the control electronics may be connected to the thermally conductive bridging element and configured to provide an electric current to the thermally conductive bridging element during use to resistively heat the thermally conductive bridging element.

The power source may form part of the aerosol-generating system. The power source may be a battery, preferably being a rechargeable battery. Where the system includes an aerosol-generating device, the device preferably includes the power source. The power source is preferably a replaceable component of the aerosol-generating device. The control electronics may comprise a DC/AC converter connectable to or connected to the power source.

The power source may comprise a first DC power source. The first DC power source may be a battery. The control circuitry may comprise a DC/AC converter connected to the first DC power source.

The control electronics preferably comprises power supply electronics configured to operate at high frequency. The power supply electronics may comprise the DC/AC converter connected to the first DC power source, the DC/AC converter including a Class-E power amplifier including a first transistor switch and an LC load network. The LC load network may comprise a shunt capacitor and a series connection of a capacitor and the inductor coil. The power supply electronics may also include a choke inductor between the first DC power source and the capacitor.

The power supply electronics preferably includes a second DC power source connected to the LC load network at a position between the capacitor and the inductor coil, for supplying DC current to the inductor coil. The second DC power source may be the same power source as the first DC power source, e.g. they may be the same battery. The power supply electronics may include a choke inductor between the second DC power source and the capacitor. The choke inductor preferably has a higher inductance value than the inductor coil. The power supply electronics may include a second switch between the second DC power source and the inductor coil. The second switch may be a second transistor switch.

The power supply electronics may include a second capacitor, the second capacitor connected in parallel with the inductor coil. This may reduce a difference between f_{susceptor} and f_{inductor coil}.

For the purpose of this application, the term “high frequency” is to be understood to denote a frequency ranging from about 1 Megahertz (MHz) to about 30 Megahertz (MHz) (including the range of 1 MHz to 30 MHz), in particular from about 1 Megahertz (MHz) to about 10 MHz (including the range of 1 MHz to 10 MHz), and even more particularly from about 5 Megahertz (MHz) to about 7 Megahertz (MHz) (including the range of 5 MHz to 7 MHz).

Class-E power amplifiers are generally known and are described in detail, for example, in the article “Class-E RF Power Amplifiers”, Nathan O. Sokal, published in the bimonthly magazine QEX, edition January/February 2001, pages 9-20, of the American Radio Relay League (ARRL), Newington, CT, U.S.A., Class-E power amplifiers are advantageous as regards operation at high frequencies, while at the same time having a simple circuit structure comprising a minimum number of components (e.g. only one transistor switch needed, which is advantageous over Class-D power amplifiers which comprise two transistor switches that must be controlled at high frequency in a manner so as to make sure that one of the two transistors has been switched off at the time the other of the two transistors is switched on). In addition, Class-E power amplifiers are known for minimum power dissipation in the switching transistor during the switching transitions. Preferably, the Class-E power amplifier is a single-ended first order Class-E power amplifier having a single transistor switch only.

The transistor switch of the Class-E power amplifier can be any type of transistor and may be embodied as a bipolar-junction transistor (BJT). More preferably, however, the transistor switch is embodied as a field effect transistor (FET) such as a metal-oxide-semiconductor field effect transistor (MOSFET) or a metal-semiconductor field effect transistor (MESFET).

The LC load network of the Class-E power amplifier is preferably configured to operate at low ohmic load. The term “low ohmic load” is to be understood to denote an ohmic load smaller than about 2 Ohms. The LC load network may comprise a shunt capacitor, and a series connection of a capacitor and an inductor having an ohmic resistance. This ohmic resistance of the inductor is typically a few tenths of an Ohm. In operation, the ohmic resistance of the susceptor adds to the ohmic resistance of the inductor and should be higher than the ohmic resistance of the inductor, since the supplied electrical power should be converted to heat in the susceptor to an as high extent as possible in order to increase efficiency of the power amplifier and to allow transfer of as much heat as possible from the susceptor to the rest of the aerosol-forming substrate to effectively produce the aerosol.

The control electronics may be configured to control the supply of electric energy from the power source to the inductor coil so as to maintain a temperature of the inductor coil at a target temperature or to follow a target temperature profile. One or both of the target temperature and the target temperature profile may be stored on a memory module or other form of data storage accessible to the control electronics.

The control electronics may be configured to control the supply of electric energy from the power source to the inductor coil so as to maintain the temperature of the susceptor at a target temperature or to follow a target temperature profile. Again, one or both of the target temperature and the target temperature profile may be stored on a memory module or other form of data storage accessible to the control electronics.

According to a second aspect of the present disclosure, there is provided a method of heating an aerosol-forming substrate of an aerosol-generating article. The method may comprise providing an electric heating arrangement comprising an inductor coil and a susceptor, the susceptor enclosed by or at least partially embedded within the aerosol-forming substrate, the susceptor at least partially within the inductor coil. The method may also comprise controlling a supply of electric energy from a power source to the inductor coil as an alternating current such that the electric heating arrangement generates heat through one or a combination of i) resistance heating of the inductor coil and ii) heating of the susceptor through inductive coupling of the inductor coil with the susceptor. The method may further comprise adjusting at least one parameter of the alternating current so as to change the inductive coupling of the inductor coil with the susceptor, thereby adjusting the balance of heat generated through inductive coupling of the inductor coil with the susceptor relative to heat generated through resistance heating of the inductor coil.

In this manner, the method facilitates changing the mode of application of heat to the aerosol-forming substate to any one of the following heating regimes: a) solely or predominantly through the resistance heating of the inductor coil; b) solely or predominantly through heating of the susceptor through the inductive coupling of the inductor coil with the susceptor; c) a combination of resistance heating of the inductor coil and heating of the susceptor through the inductive coupling of the inductor coil with the susceptor.

As described for the first aspect of the present disclosure, adjusting the balance of heat generated through inductive coupling of the inductor coil with the susceptor relative to heat generated through resistance heating of the inductor coil may facilitate more uniform heating of the aerosol-forming substrate and may provide for improved depletion of the substrate.

Again as described above for the first aspect of the present disclosure, the at least one parameter preferably comprises a frequency of the alternating current. Additionally or alternatively, the parameter may comprise a magnitude of the alternating current.

The method may comprise adjusting the frequency of the alternating current from a first frequency value or range of values to a second frequency value or range of values. The first frequency value or range of values correspond to a first heating state of the electric heating arrangement and the second frequency value or range of values correspond to a second heating state of the electric heating arrangement. The second frequency value or range of values may be closer than the first frequency value or range of values to a resonant frequency of the electric heating arrangement, such that the inductive coupling of the inductor coil with the susceptor is increased in the second heating state compared to the first heating state.

Advantageously, the adjusting of the frequency of the alternating current between the first and second value or range of values may be triggered as a function of one or more of: a) a puff count over a usage session; b) time elapsed since commencement of a usage session; c) detection of a puff in a usage session. As indicated for the first aspect of the present disclosure, detecting the application of a puff may be performed by use of a pressure sensor or a temperature sensor. The heating arrangement may itself function as a means of determining temperature or changes in temperature, or of detecting or determining changes in temperature.

The frequency of the alternating current may be adjusted from the first frequency value or range of values to the second frequency value or range of values in response to a puff being applied to the aerosol-generating article or to an aerosol-generating device in which the aerosol-generating article is received. The method may further comprise maintaining the frequency of the alternating current at the second frequency value or range of values for a predetermined period of time after commencement of the applied puff. The predetermined period of time may equate to or exceed a duration of the applied puff.

The method may comprise, after elapse of the predetermined period of time, adjusting the frequency of the alternating current from the second frequency value or range of values to a third frequency value or range of values. The third frequency value or range of values may correspond to a third heating state of the electric heating arrangement. The third frequency value or range of values may be farther away than the second frequency value or range of values to the resonant frequency of the electric heating arrangement, such that the inductive coupling of the inductor coil with the susceptor is reduced in the third heating state compared to the second heating state. As discussed for the first aspect of the present disclosure, each of the first, second and third heating states may be different to each other; for example, each heating state may be associated with a different level of heating generated by the heating arrangement. Each of the first, second and third heating states may be associated with different corresponding target operating temperatures for the aerosol-forming substrate.

As for the first aspect of the present disclosure, the resonant frequency may be determined according to the following equation:

$${f}_{R} = \frac{1}{2 π \sqrt{L C}}$$

in which f_{R} is the resonant frequency, L is an inductance of the electric heating arrangement and C is a capacitance of the electric heating arrangement.

Advantageously, controlling a supply of electric energy from a power source to the inductor coil may further comprise supplying the inductor coil with a direct current.

The method may further comprise activating or adjusting the supply of direct current to the inductor coil as a function of one or more of: a) a puff count over a usage session; b) time elapsed since commencement of a usage session; c) detection of a puff in a usage session. The method may comprise activating or increasing the supply of direct current to the inductor coil in response to a puff being applied to the aerosol-generating article or to an aerosol-generating device in which the aerosol-generating article is received.

Conveniently, the method may comprise switching between one or more of the following operational states: a) a first operational state in which the inductor coil is supplied with alternating current alone; b) a second operational state in which the inductor coil is supplied with direct current alone; and c) a third operational state in which the inductor coil is supplied with both alternating current and direct current.

Each of the first, second and third operational states may be associated with different corresponding levels of heating provided by the heating arrangement. Each of the first, second and third operational states may be associated with different corresponding target operating temperatures for the aerosol-forming substrate.

Preferably, the method may comprise selecting between different ones of the first, second and third operational states as a function of one or more of: a) a puff count over a usage session; b) time elapsed since commencement of a usage session; and c) detection of a puff in a usage session.

The method may comprise arranging the inductor coil to be in surface contact with an exterior surface of the aerosol-generating article.

The method may comprise thermally coupling the inductor coil with an exterior surface of the aerosol-generating article by use of a thermally conductive bridging element extending between the inductor coil and the exterior surface of the aerosol-generating article. The thermally conductive bridging element may comprise a sleeve, the sleeve disposed radially inward of the inductor coil.

The inductor coil and the thermally conductive bridging element may be as described for the first aspect of the present disclosure.

The method may comprise controlling the supply of electric energy from the power source to the inductor coil so as to maintain a temperature of the inductor coil at a target temperature or to follow a target temperature profile.

The method may comprise controlling the supply of electric energy from the power source to the inductor coil so as to maintain the temperature of the susceptor at a target temperature or to follow a target temperature profile.

As used herein, the term “aerosol-generating system” is used to describe a plurality of elements configured to provide an interaction with an aerosol-forming substrate to generate an aerosol.

As used herein, the term “aerosol-generating device” is used to describe a device that interacts with an aerosol-forming substrate to generate an aerosol. Preferably, the aerosol-generating device is a smoking device that interacts with an aerosol-forming substrate to generate an aerosol that is directly inhalable into a user's lungs thorough the user's mouth.

As used herein, the term “aerosol-forming substrate” refers to a substrate consisting of or comprising an aerosol-forming material that is capable of releasing volatile compounds upon heating to generate an aerosol.

Preferably, the aerosol-forming substrate is a solid aerosol-forming substrate. However, the aerosol-forming substrate may comprise both solid and liquid components. Alternatively, the aerosol-forming substrate may be a liquid aerosol-forming substrate.

Preferably, the aerosol-forming substrate comprises nicotine. More preferably, the aerosol-forming substrate comprises tobacco. Alternatively or in addition, the aerosol-forming substrate may comprise a non-tobacco containing aerosol-forming material.

If the aerosol-forming substrate is a solid aerosol-forming substrate, the solid aerosol-forming substrate may comprise, for example, one or more of: powder, granules, pellets, shreds, strands, strips or sheets containing one or more of: herb leaf, tobacco leaf, tobacco ribs, expanded tobacco and homogenised tobacco.

Optionally, the solid aerosol-forming substrate may contain tobacco or non-tobacco volatile flavour compounds, which are released upon heating of the solid aerosol-forming substrate. The solid aerosol-forming substrate may also contain one or more capsules that, for example, include additional tobacco volatile flavour compounds or non-tobacco volatile flavour compounds and such capsules may melt during heating of the solid aerosol-forming substrate.

Optionally, the solid aerosol-forming substrate may be provided on or embedded in a thermally stable carrier. The carrier may take the form of powder, granules, pellets, shreds, strands, strips or sheets. The solid aerosol-forming substrate may be deposited on the surface of the carrier in the form of, for example, a sheet, foam, gel or slurry. The solid aerosol-forming substrate may be deposited on the entire surface of the carrier, or alternatively, may be deposited in a pattern in order to provide a non-uniform flavour delivery during use.

In a preferred embodiment, the aerosol-forming substrate comprises homogenised tobacco material. As used herein, the term “homogenised tobacco material” refers to a material formed by agglomerating particulate tobacco.

Preferably, the aerosol-forming substrate comprises a gathered sheet of homogenised tobacco material. As used herein, the term “sheet” refers to a laminar element having a width and length substantially greater than the thickness thereof. As used herein, the term “gathered” is used to describe a sheet that is convoluted, folded, or otherwise compressed or constricted substantially transversely to the longitudinal axis of the aerosol-generating article. Preferably, the aerosol-forming substrate comprises an aerosol former. As used herein, the term “aerosol former” is used to describe any suitable known compound or mixture of compounds that, in use, facilitates formation of an aerosol and that is substantially resistant to thermal degradation at the operating temperature of the aerosol-generating article.

Suitable aerosol-formers are known in the art and include, but are not limited to: polyhydric alcohols, such as propylene glycol, triethylene glycol, 1,3-butanediol and glycerine; esters of polyhydric alcohols, such as glycerol mono-, di- or triacetate; and aliphatic esters of mono-, di- or polycarboxylic acids, such as dimethyl dodecanedioate and dimethyl tetradecanedioate. Preferred aerosol formers are polyhydric alcohols or mixtures thereof, such as propylene glycol, triethylene glycol, 1,3-butanediol and, most preferred, glycerine.

The aerosol-forming substrate may comprise a single aerosol former. Alternatively, the aerosol-forming substrate may comprise a combination of two or more aerosol formers.

As used herein, the term “aerosol-generating article” refers to an article comprising an aerosol-forming substrate that is capable of releasing volatile compounds that can form an aerosol. An aerosol-generating article may be disposable.

As used herein, the term “usage session” refers to a period in which a series of puffs are applied by a user to extract aerosol from an aerosol-forming substrate.

As used herein, the term “mouthpiece” refers to a portion of an aerosol-generating article, an aerosol-generating device or an aerosol-delivery system that is placed into a user's mouth in order to directly inhale an aerosol.

As used herein, the term “susceptor” refers to an element comprising a material that is capable of converting the energy of a magnetic field into heat. When a susceptor is located in an alternating magnetic field, the susceptor is heated. Heating of the susceptor may be the result of at least one of hysteresis losses and eddy currents induced in the susceptor, depending on the electrical and magnetic properties of the susceptor material.

As used herein, the term “inductively couple” refers to the heating of a susceptor when penetrated by an alternating magnetic field. The heating may be caused by the generation of eddy currents in the susceptor. The heating may be caused by magnetic hysteresis losses.

As used herein, the term “puff” means the action of a user drawing an aerosol into their body through their mouth or nose.

As used herein when referring to an aerosol-generating device, the terms “upstream” and “front”, and “downstream” and “rear”, are used to describe the relative positions of components, or portions of components, of the aerosol-generating device in relation to the direction in which air flows through the aerosol-generating device during use thereof. Aerosol-generating devices according to the invention comprise a proximal end through which, in use, an aerosol exits the device. The proximal end of the aerosol-generating device may also be referred to as the mouth end or the downstream end. The mouth end is downstream of the distal end. The distal end of the aerosol-generating device may also be referred to as the upstream end. Components, or portions of components, of the aerosol-generating device may be described as being upstream or downstream of one another based on their relative positions with respect to the airflow path of the aerosol-generating device.

As used herein when referring to an aerosol-generating article, the terms “upstream” and “front”, and “downstream” and “rear”, are used to describe the relative positions of components, or portions of components, of the aerosol-generating article in relation to the direction in which air flows through the aerosol-generating article during use thereof. Aerosol-generating articles according to the invention comprise a proximal end through which, in use, an aerosol exits the article. The proximal end of the aerosol-generating article may also be referred to as the mouth end or the downstream end. The mouth end is downstream of the distal end. The distal end of the aerosol-generating article may also be referred to as the upstream end. Components, or portions of components, of the aerosol-generating article may be described as being upstream or downstream of one another based on their relative positions between the proximal end of the aerosol-generating article and the distal end of the aerosol-generating article. The front of a component, or portion of a component, of the aerosol-generating article is the portion at the end closest to the upstream end of the aerosol-generating article. The rear of a component, or portion of a component, of the aerosol-generating article is the portion at the end closest to the downstream end of the aerosol-generating article.

The invention is defined in the claims. However, below there is provided a non-exhaustive list of non-limiting examples. Any one or more of the features of these examples may be combined with any one or more features of another example, embodiment, or aspect described herein.

Example Ex1: An aerosol-generating system for generating an aerosol from an aerosol-forming substrate of an aerosol-generating article, the aerosol-generating system comprising:
control electronics;
an electric heating arrangement, the electric heating arrangement comprising an inductor coil and a susceptor, the susceptor positioned or positionable such that the susceptor is at least partially within the inductor coil;
wherein the control electronics are configured to supply electric energy from a power source to the inductor coil as an alternating current such that the electric heating arrangement is operable to generate heat through one or a combination of i) resistance heating of the inductor coil and ii) heating of the susceptor through inductive coupling of the inductor coil with the susceptor;
the control electronics configured to adjust at least one parameter of the alternating current so as to change the inductive coupling of the inductor coil with the susceptor, thereby adjusting the balance of heat generated through inductive coupling of the inductor coil with the susceptor relative to heat generated through resistance heating of the inductor coil.

Example Ex2: An aerosol-generating system according to Ex1, wherein the at least one parameter comprises at least one of a frequency of the alternating current and a magnitude of the alternating current.

Example Ex3: An aerosol-generating system according to Ex2, wherein the control electronics are configured to adjust the frequency of the alternating current from a first frequency value or range of values to a second frequency value or range of values, the first frequency value or range of values corresponding to a first heating state of the electric heating arrangement and the second frequency value or range of values corresponding to a second heating state of the electric heating arrangement;

the second frequency value or range of values being closer than the first frequency value or range of values to a resonant frequency of the electric heating arrangement, such that the inductive coupling of the inductor coil with the susceptor is increased in the second heating state compared to the first heating state.

Example Ex4: An aerosol-generating system according to Ex3, wherein the control electronics are configured to trigger adjustment of the frequency of the alternating current between the first and second values or range of values as a function of one or more of:
a) a puff count over a usage session;
b) time elapsed since commencement of a usage session;
c) detection of a puff in a usage session.

Example Ex5: An aerosol-generating system according to Ex4, wherein the control electronics are configured to adjust the frequency of the alternating current from the first frequency value or range of values to the second frequency value or range of values in response to receiving a signal indicative of a puff being applied to the aerosol-generating system.

Example Ex6: An aerosol-generating system according to Ex5, wherein the control electronics are configured to maintain the frequency of the alternating current at the second frequency value or range of values for a predetermined period of time after receiving the signal indicative of a puff being applied to the aerosol-generating system.

Example Ex7: An aerosol-generating system according to Ex6, wherein the control electronics are configured such that the predetermined period of time equates to or exceeds a duration of the applied puff.

Example Ex8: An aerosol-generating system according to either one of Ex6 or Ex7, wherein the control electronics are configured to, after elapse of the predetermined period of time, adjust the frequency of the alternating current from the second frequency value or range of values to a third frequency value or range of values, the third frequency value or range of values corresponding to a third heating state of the electric heating arrangement, the third frequency value or range of values being farther away than the second frequency value or range of values from the resonant frequency of the electric heating arrangement, such that the inductive coupling of the inductor coil with the susceptor is reduced in the third heating state compared to the second heating state.

Example Ex9: An aerosol-generating system according to any one of Ex3 to Ex8, wherein the resonant frequency is determined according to the following equation:

$${f}_{R} = \frac{1}{2 π \sqrt{L C}}$$

in which f_{R} is the resonant frequency, L is an inductance of the electric heating arrangement and C is a capacitance of the electric heating arrangement.

Example Ex10: An aerosol-generating system according to any one of Ex1 to Ex9, wherein the wherein the control electronics are further configured to supply electric energy from a power source to the inductor coil as a direct current.

Example Ex11: An aerosol-generating system according to Ex10, wherein the control electronics are configured to activate or adjust the supply of direct current to the inductor coil as a function of one or more of:
a) a puff count over a usage session;
b) time elapsed since commencement of a usage session;
c) detection of a puff in a usage session.

Example Ex12: An aerosol-generating system according to Ex11, wherein the control electronics are configured to activate or increase the supply of direct current to the inductor coil in response to the control electronics receiving a signal indicative of a puff being applied to the aerosol-generating system.

Example Ex13: An aerosol-generating system according to any one of Ex10 to Ex12, wherein the control electronics are configured to switch between one or more of the following operational states:
a first operational state in which the inductor coil is supplied with alternating current alone;
a second operational state in which the inductor coil is supplied with direct current alone; and
a third operational state in which the inductor coil is supplied with both alternating current and direct current.

Example Ex14: An aerosol-generating system according to Ex13, wherein the control electronics are configured to select between different ones of the first, second and third operational states as a function of one or more of:
a) a puff count over a usage session;
b) time elapsed since commencement of a usage session; and
c) detection of a puff in a usage session.

Example Ex15: An aerosol-generating system according to any one of Ex1 to Ex14, wherein the inductor coil is formed in an electrically conductive tubular member, wherein one or more cut-outs are provided in the tubular member to thereby define the shape and configuration of the inductor coil.

Example Ex16: An aerosol-generating system according to any one of Ex1 to Ex15, the aerosol-generating system comprising an aerosol-generating device;
the aerosol-generating device comprising the inductor coil, the susceptor and a chamber;
the inductor coil surrounding or at least partially defining a peripheral wall of the chamber;
the susceptor arranged within the chamber;
wherein the chamber is configured to receive an aerosol-generating article comprising an aerosol-forming substrate such that the susceptor inserts within the aerosol-generating article.

Example Ex17: An aerosol-generating system according to Ex16, wherein the susceptor extends from a base of the chamber along a longitudinal axis of the chamber.

Example Ex18: An aerosol-generating system according to either one of Ex16 or Ex17, the aerosol-generating system further comprising the aerosol-generating article, wherein one or both of the aerosol-generating device and the aerosol-generating article are configured such that, on the aerosol-generating article being received in the chamber, the susceptor is enclosed by or at least partially embedded within the aerosol-forming substrate of the aerosol-generating article.

Example Ex19: An aerosol-generating system according to any one of Ex16 to Ex18, wherein the susceptor forms all or part of a pin or blade configured to penetrate the aerosol-forming article when the aerosol-forming article is received in the chamber.

Example Ex20: An aerosol-generating system according to any one of Ex1 to Ex15, the aerosol-generating system comprising an aerosol-generating device and an aerosol-generating article;
the aerosol-generating device comprising the inductor coil and a chamber, the inductor coil surrounding or at least partially defining a peripheral wall of the chamber;
the aerosol-generating article comprising an aerosol-forming substrate and the susceptor, the susceptor enclosed by or at least partially embedded within the aerosol-forming substrate;
wherein the chamber is configured to receive the aerosol-generating article such that the susceptor is positioned at least partially within the inductor coil.

Example Ex21: An aerosol-generating system according to any one of Ex16 to Ex20, wherein the inductor coil is configured to be in surface contact with an exterior surface of the aerosol-generating article upon the aerosol-generating article being received in the chamber.

Example Ex22: An aerosol-generating system according to any one of Ex16 to Ex20, further comprising a thermally conductive bridging element configured to extend between the inductor coil and an exterior surface of the aerosol-generating article when the article is received in the chamber of the aerosol-generating device.

Example Ex23: An aerosol-generating system according to Ex22, wherein the thermally conductive bridging element comprises a sleeve disposed radially inward of the inductor coil.

Example Ex24: An aerosol-generating system according to Ex23, wherein the sleeve at least partially defines a peripheral wall of the chamber.

Example Ex25: An aerosol-generating system according to any one of Ex1 to Ex24, wherein the system comprises the power source.

Example Ex26: An aerosol-generating device according to Ex25, wherein the power source comprises a battery.

Example Ex27: An aerosol-generating system according to any one of Ex1 to Ex26, wherein the control electronics comprises a DC/AC converter connectable to or connected to the power source.

Example Ex28: An aerosol-generating system according to any one of Ex1 to Ex27, wherein the control electronics are configured to control the supply of electric energy from the power source to the inductor coil so as to maintain a temperature of the inductor coil at a target temperature or to follow a target temperature profile.

Example Ex29: An aerosol-generating system according to any one of Ex1 to Ex28, wherein the control electronics are configured to control the supply of electric energy from the power source to the inductor coil so as to maintain the temperature of the susceptor at a target temperature or to follow a target temperature profile.

Example Ex30: A method of heating an aerosol-forming substrate of an aerosol-generating article, the method comprising:
providing an electric heating arrangement comprising an inductor coil and a susceptor, the susceptor enclosed by or at least partially embedded within the aerosol-forming substrate, the susceptor at least partially within the inductor coil;
controlling a supply of electric energy from a power source to the inductor coil as an alternating current such that the electric heating arrangement generates heat through one or a combination of i) resistance heating of the inductor coil and ii) heating of the susceptor through inductive coupling of the inductor coil with the susceptor; and
adjusting at least one parameter of the alternating current so as to change the inductive coupling of the inductor coil with the susceptor, thereby adjusting the balance of heat generated through inductive coupling of the inductor coil with the susceptor relative to heat generated through resistance heating of the inductor coil.

Example Ex31: A method according to Ex30, wherein the at least one parameter comprises at least one of a frequency of the alternating current and a magnitude of the alternating current.

Example Ex32: A method according to Ex31, comprising:
adjusting the frequency of the alternating current from a first frequency value or range of values to a second frequency value or range of values, the first frequency value or range of values corresponding to a first heating state of the electric heating arrangement and the second frequency value or range of values corresponding to a second heating state of the electric heating arrangement, the second frequency value or range of values being closer than the first frequency value or range of values to a resonant frequency of the electric heating arrangement, such that the inductive coupling of the inductor coil with the susceptor is increased in the second heating state compared to the first heating state.

Example Ex33: A method according to Ex32, wherein the adjusting of the frequency of the alternating current between the first and second value or range of values is triggered as a function of one or more of:
a) a puff count over a usage session;
b) time elapsed since commencement of a usage session;
c) detection of a puff in a usage session

Example Ex34: A method according to Ex33, wherein the frequency of the alternating current is adjusted from the first frequency value or range of values to the second frequency value or range of values in response to a puff being applied to the aerosol-generating article or to an aerosol-generating device in which the aerosol-generating article is received.

Example Ex35: A method according to Ex34, comprising maintaining the frequency of the alternating current at the second frequency value or range of values for a predetermined period of time after commencement of the applied puff.

Example Ex36: A method according to Ex35, wherein the predetermined period of time equates to or exceeds a duration of the applied puff.

Example Ex37: A method according to either one of Ex35 or Ex36, comprising:
after elapse of the predetermined period of time, adjusting the frequency of the alternating current from the second frequency value or range of values to a third frequency value or range of values, the third frequency value or range of values corresponding to a third heating state of the electric heating arrangement, the third frequency value or range of values being farther away than the second frequency value or range of values to the resonant frequency of the electric heating arrangement, such that the inductive coupling of the inductor coil with the susceptor is reduced in the third heating state compared to the second heating state.

Example Ex38: A method according to Ex32 to Ex37, wherein the resonant frequency is determined according to the following equation:

$${f}_{R} = \frac{1}{2 π \sqrt{L C}}$$

in which f_{R} is the resonant frequency, L is an inductance of the electric heating arrangement and C is a capacitance of the electric heating arrangement.

Example Ex39: A method according to any one of Ex30 to Ex38, wherein controlling a supply of electric energy from a power source to the inductor coil further comprises supplying the inductor coil with a direct current.

Example Ex40: A method according to Ex39, comprising activating or adjusting the supply of direct current to the inductor coil as a function of one or more of:
a) a puff count over a usage session;
b) time elapsed since commencement of a usage session;
c) detection of a puff in a usage session.

Example Ex41: A method according to Ex40, comprising activating or increasing the supply of direct current to the inductor coil in response to a puff being applied to the aerosol-generating article or to an aerosol-generating device in which the aerosol-generating article is received.

Example Ex42: A method according to any of Ex39 to Ex41, comprising switching between one or more of the following operational states:
a first operational state in which the inductor coil is supplied with alternating current alone;
a second operational state in which the inductor coil is supplied with direct current alone;
a third operational state in which the inductor coil is supplied with both alternating current and direct current.

Example Ex43: A method according to Ex42, comprising selecting between different ones of the first, second and third operational states as a function of one or more of:
a) a puff count over a usage session;
b) time elapsed since commencement of a usage session;
c) detection of a puff in a usage session.

Example Ex44: A method according to any one of Ex30 to Ex43, comprising arranging the inductor coil to be in surface contact with an exterior surface of the aerosol-generating article.

Example Ex45: A method according to any one of Ex30 to Ex43, comprising thermally coupling the inductor coil with an exterior surface of the aerosol-generating article by use of a thermally conductive bridging element extending between the inductor coil and the exterior surface of the aerosol-generating article.

Example Ex46: A method according to Ex45, wherein the thermally conductive bridging element comprises a sleeve, the sleeve disposed radially inward of the inductor coil.

Example Ex47: A method according to any one of Ex30 to Ex46, further comprising controlling the supply of electric energy from the power source to the inductor coil so as to maintain a temperature of the inductor coil at a target temperature or to follow a target temperature profile.

Example Ex48: A method according to any one of Ex30 to Ex47, further comprising controlling the supply of electric energy from the power source to the inductor coil so as to maintain the temperature of the susceptor at a target temperature or to follow a target temperature profile.

The invention is further described, by way of example only, with reference to the accompanying drawings in which:

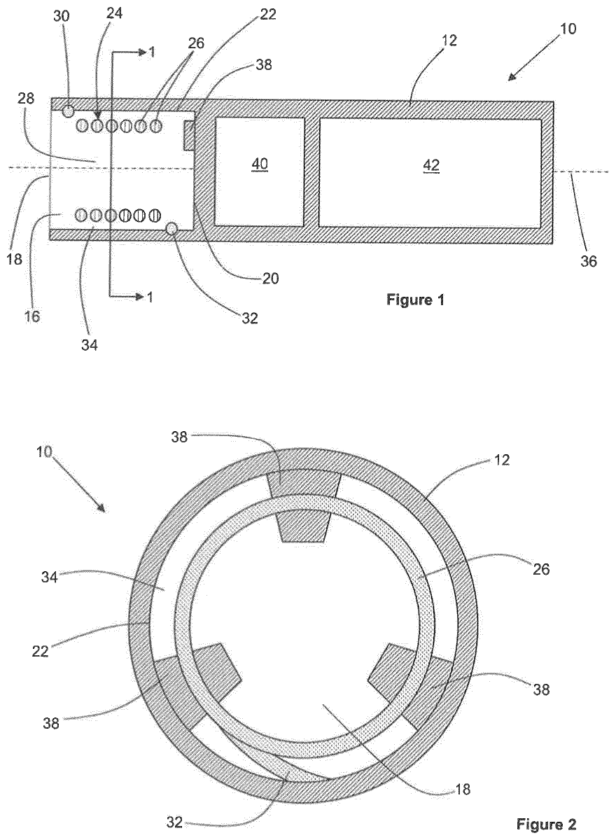

FIG. 1 shows a side cross-sectional view of an aerosol-generating device according to a first embodiment;

FIG. 2 shows an axial cross-sectional view of the aerosol-generating device of FIG. 1 along line 1-1;

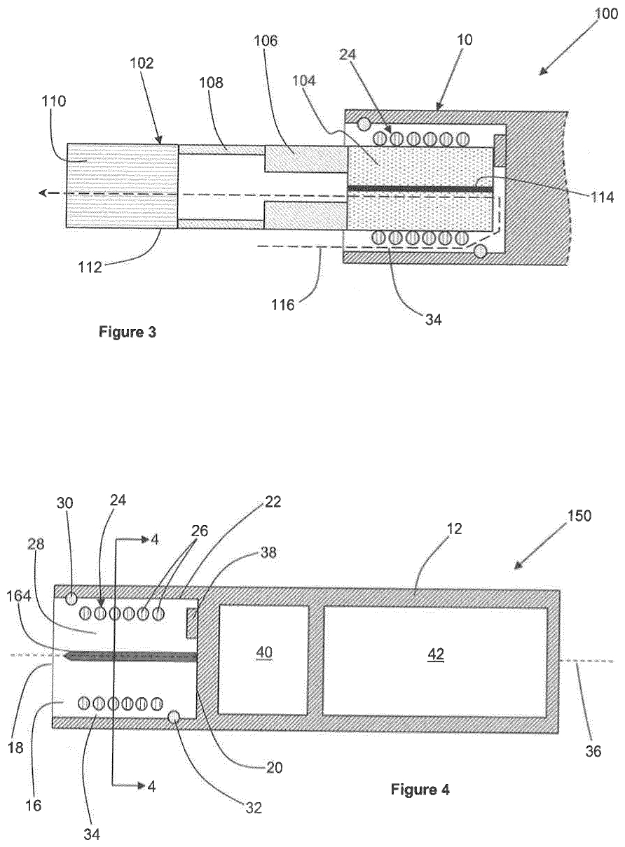

FIG. 3 shows a side cross-sectional view of an aerosol-generating system comprising the aerosol-generating device of FIG. 1;

FIG. 4 shows a side cross-sectional view of an aerosol-generating device according to a second embodiment;

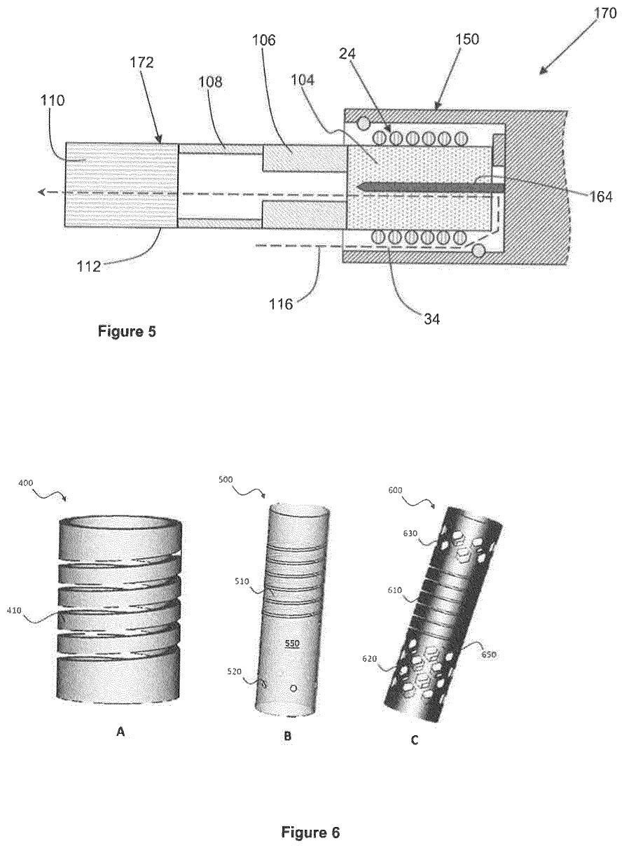

FIG. 5 shows a side cross-sectional view of an aerosol-generating system comprising the aerosol-generating device of FIG. 4;

FIG. 6 illustrates possible forms of inductor coil for the devices of FIGS. 1 to 5;

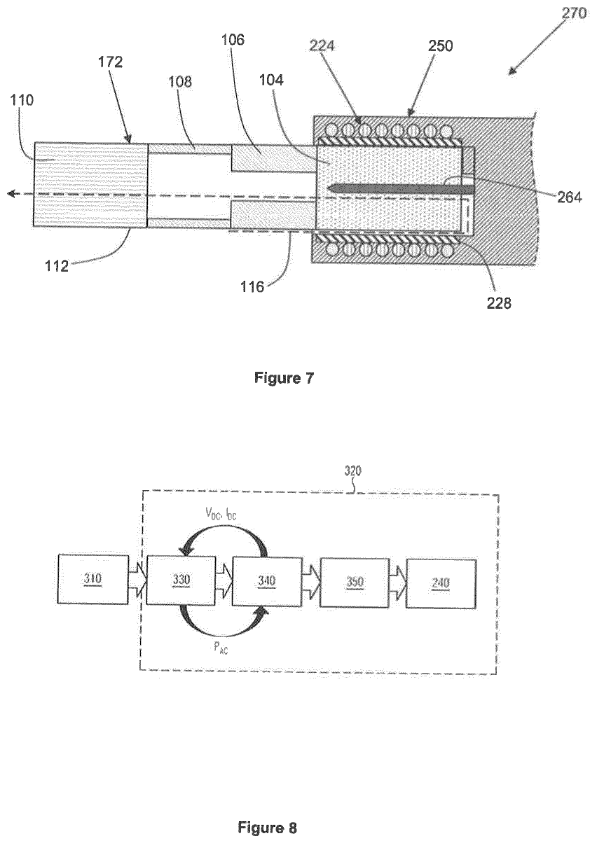

FIG. 7 illustrates the provision of a thermal bridging element between an inductor coil and an aerosol-generating article;

FIG. 8 is a block diagram showing an inductive heating arrangement of the aerosol-generating devices described in relation to FIGS. 1 to 5;

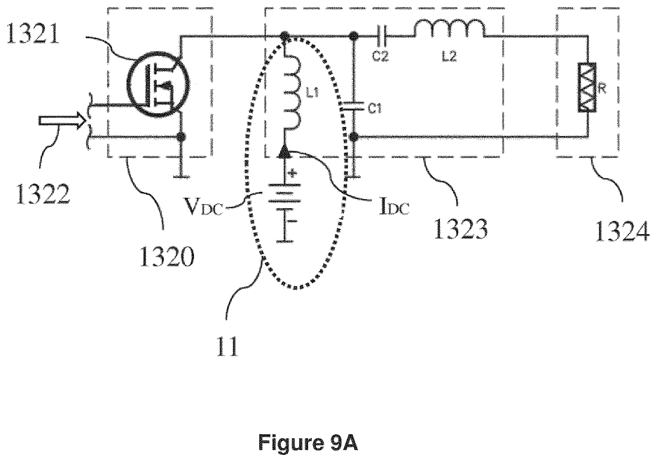

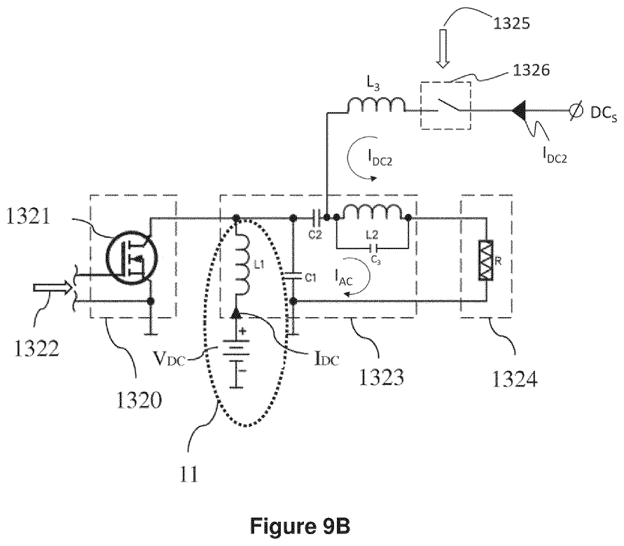

FIG. 9A is a schematic diagram showing a first embodiment of electrical circuitry of the aerosol-generating devices described in relation to FIGS. 1 to 5;

FIG. 9B is a schematic diagram showing a second embodiment of electrical circuitry of the aerosol-generating devices described in relation to FIGS. 1 to 5;

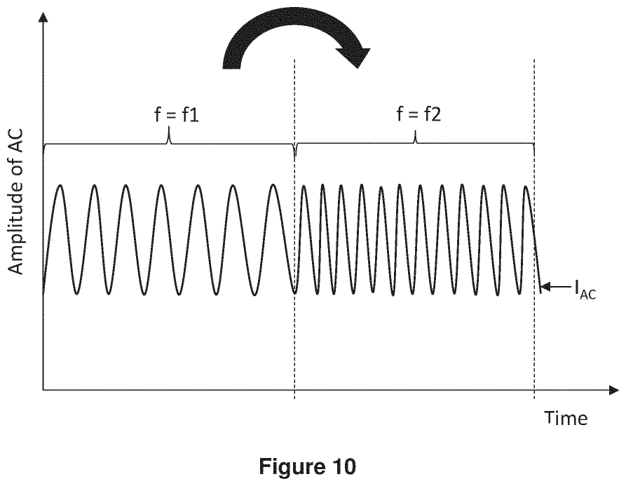

FIG. 10 illustrates the application of AC current to an inductor coil over first and second phases of operation and a change in frequency of the AC current between the first and second phases;

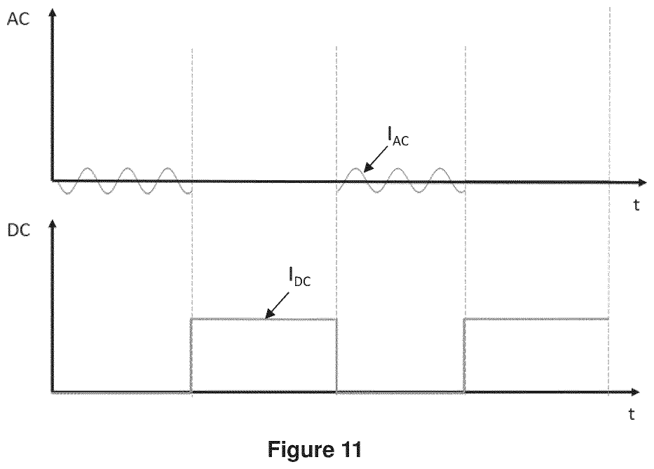

FIG. 11 illustrates the alternate application of AC and DC current to an inductor coil in successive phases of operation;

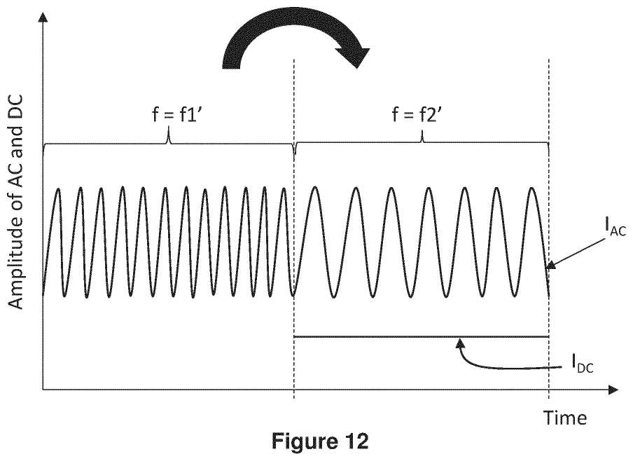

FIG. 12 illustrates the simultaneous application of AC and DC current to an inductor coil during at least one phase of operation and a change in frequency of the AC current between successive phases;

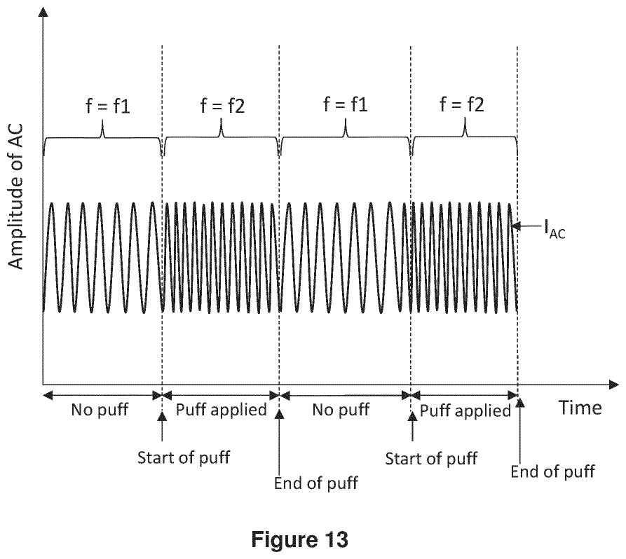

FIG. 13 illustrates the application of AC current to an inductor coil and a change in frequency of the AC current according to whether or not a puff is applied;

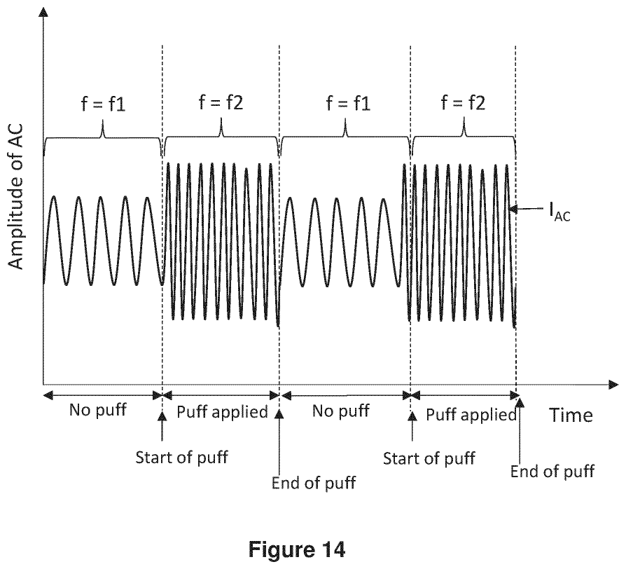

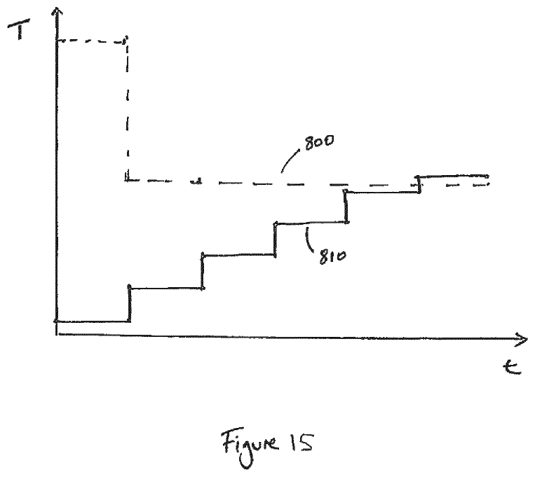

FIG. 14 is a variation to FIG. 13, in which both the frequency and magnitude of the AC current is varied according to whether or not a puff is applied.

FIG. 15 illustrates target temperature profiles for a susceptor element and an inductor coil in an aerosol-generating system as described with reference to FIGS. 1 to 5.

FIGS. 1 and 2 show an aerosol-generating device 10 in accordance with a first embodiment. The aerosol-generating device 10 comprises a housing 12 defining a chamber 16 for receiving a portion of an aerosol-generating article. The chamber 16 comprises an open end 18 through which an aerosol-generating article may be inserted into the chamber 16 and a closed end 20 opposite the open end 18. A cylindrical wall 22 of the chamber 16 extends between the open end 18 and the closed end 20.

The aerosol-generating device 10 also comprises an inductor coil 24 comprising a plurality of windings 26 disposed within the chamber 16. The plurality of windings 26 of the inductor coil 24 define a lumen 28 in which a portion of an aerosol-generating article is received when the aerosol-generating article is inserted into the chamber 16. Advantageously, positioning the inductor coil 24 in direct contact with an aerosol-generating article received within the chamber 16 facilitates the transfer of heat generated by resistive heating of the inductor coil 24 to the aerosol-generating article.

The inductor coil 24 comprises a first end 30 positioned towards the open end 18 of the chamber 16 and a second end 32 positioned towards the closed end 20 of the chamber 16. Each of the first end 30 and the second end 32 is received within a portion of the cylindrical wall 22 of the chamber 16 to retain the inductor coil 24 within the chamber 16. The cylindrical wall 22 of the chamber 16 may define first and second recesses, slots, or apertures in which the first and second ends 30, 32 of the inductor coil 24 are respectively received. Alternatively, the first and second ends 30, 32 of the inductor coil 24 may be secured to the cylindrical wall 22 of the chamber 16 by overmoulding the housing 12 over the first and second ends 30, 32 of the inductor coil 24 during manufacture of the housing 12.

The inductor coil 24 is suspended within the chamber 16 by the first and second ends 30, 32 of the inductor coil 24 so that the windings 26 of the inductor coil 24 are spaced apart from the cylindrical wall 22 of the chamber 16. Therefore, the inductor coil 24 contacts the housing 12 only at the first and second ends 30, 32 of the inductor coil 24. Spacing the windings 26 of the inductor coil 24 from the cylindrical wall 22 of the chamber 16 defines an annular gap 34 between the cylindrical wall 22 of the chamber 16 and the windings 26 of the inductor coil 24. Advantageously, the annular gap 34 reduces or minimises the transfer of heat generated by resistive heating of the inductor coil 24 to the housing 12.

Advantageously, the annular gap 34 facilitates airflow through the chamber 16 when an aerosol-generating article is received within the chamber 16.

To facilitate insertion of an aerosol-generating article into the chamber 16, the inductor coil 24 is arranged concentrically about a central axis 36 of the aerosol-generating device 10. To facilitate a secure positioning of the inductor coil 24 in the chamber 16, the first and second ends 30, 32 of the inductor coil 24 are retained by diametrically opposed portions of the cylindrical wall 22 of the chamber 16.

The housing 12 also defines a plurality of protrusions 38 extending into the chamber 16 from the closed end 20 of the chamber 16. As will be further described below, the plurality of protrusions 38 function to maintain a gap between an end of an aerosol-generating article and the closed end 20 of the chamber 16 when the aerosol-generating article is fully inserted into the chamber 16. In the embodiment shown in FIGS. 1 and 2, the housing 12 defines three protrusions 38 spaced equidistantly about the central axis 36 of the aerosol-generating device 10. The skilled person will appreciate that the housing 12 may define more or fewer protrusions 38 and the arrangement of the protrusions 38 at the closed end 20 of the chamber 16 may be varied.

The aerosol-generating device 10 also comprises control circuitry 40 and a power supply 42 connected to the inductor coil 24. The control circuitry 40 is configured to provide an alternating electric current from the power supply 42 to the inductor coil 24 to generate an alternating magnetic field.

FIG. 3 shows a cross-sectional view of an aerosol-generating system 100 comprising the aerosol-generating device 10 of FIG. 1 and an aerosol-generating article 102.

The aerosol-generating article 102 comprises an aerosol-forming substrate 104 in the form of a tobacco plug, a first hollow acetate tube 106, a second hollow acetate tube 108, a mouthpiece 110, and an outer wrapper 112. The aerosol-generating article 102 also comprises a susceptor element 114 arranged within the aerosol-forming substrate 104. During use, a portion of the aerosol-generating article 102 is inserted into the chamber 16 and the inductor coil 24 so that the aerosol-forming substrate 104 and the susceptor element 114 are positioned inside the lumen 28 defined by the inductor coil 24. The control circuitry 40 provides an alternating electric current from the power supply 42 to the inductor coil 24 to generate an alternating magnetic field that inductively heats the susceptor element 114, which heats the aerosol-forming substrate 104 to generate an aerosol. As is described in more detail below, the level of inductive coupling between the inductor coil 24 and the susceptor element 114 (and consequently, the heating of the susceptor 114) is affected by the frequency of the alternating current to the inductor coil 24.

Airflow through the aerosol-generating system 100 during use is illustrated by the dashed line 116 in FIG. 3. When a user draws on the mouthpiece 110 of the aerosol-generating article 102, a negative pressure is generated in the chamber 16. The negative pressure draws air into the chamber 16 via the open end 18 of the chamber. The air entering the chamber 16 then flows through the annular gap 34 between the inductor coil 24 and the cylindrical wall 22 of the chamber 16. When the airflow reaches the closed end 20 of the chamber 16, the air enters the aerosol-generating article 102 through the aerosol-forming substrate 104. Airflow into the aerosol-generating article 102 is facilitated by the gap maintained between the upstream end of the aerosol-generating article 102 and the closed end 20 of the chamber 16 by the plurality of protrusions 38. As the airflow passes through the aerosol-forming substrate 104, aerosol generated by heating of the aerosol-forming substrate 104 is entrained in the airflow. The aerosol then flows along the length of the aerosol-generating article 102 and through the mouthpiece 110 to the user.

FIG. 4 shows a cross-sectional view of an aerosol-generating device 150 according to a second embodiment. The aerosol-generating device 150 is similar to the aerosol-generating device 10 described with reference to FIGS. 1 and 2 and like reference numerals are used to designate like parts.

The aerosol-generating device 150 differs from the aerosol-generating device 10 by the addition of a susceptor element 164. The susceptor element 164 has an elongate shape and extends into the chamber 16 from the closed end 20 of the chamber 16. The susceptor element 164 extends along the central axis 36 of the aerosol-generating device 150 so that the inductor coil 24 extends concentrically around the susceptor element 164.

FIG. 5 shows a cross-sectional view of an aerosol-generating system 170 comprising the aerosol-generating device 150 of FIG. 4 and an aerosol-generating article 172. The aerosol-generating system 170 is similar to the aerosol-generating system 100 described with reference to FIG. 3 and like reference numerals are used to designate like parts.

The aerosol-generating system 170 differs from aerosol-generating system 100 by the absence of a susceptor element in the aerosol-generating article 172. When the aerosol-generating article 172 is inserted into the chamber 16, the susceptor element 164 of the aerosol-generating device 150 is received within the aerosol-forming substrate 104 of the aerosol-generating article 172. FIGS. 4 and 5 show the susceptor element 164 as having a pin- or blade-shaped profile, thereby facilitating penetration of the aerosol-forming substrate 104 by the susceptor element 164 during insertion of the aerosol-generating article 172 into the chamber 16 of the aerosol-generating device 150. The skilled person will appreciate that the susceptor element 164 may have a profile other than that shown in FIGS. 4 and 5.

Once the aerosol-generating article 172 has been inserted into the chamber 16, the operation of the aerosol-generating system 170 is identical to the operation of the aerosol-generating system 100 described with reference to FIG. 3.

FIG. 6 illustrates three possible alternative coil structures for the devices illustrated in FIGS. 1 to 5.

A first coil structure is marked as coil structure A. Coil structure A comprises a sleeve 400. A helical coil section 410 is formed by removal of material from the sleeve 400.

An insulating material may be arranged within the gaps where the material of the sleeve 400 has been removed. This has the advantage of structurally reinforcing the coil structure and may also facilitate the insertion of the aerosol generating article. It is also possible to wrap or overmould a layer of insulating material, like polyimide tape, around the helical coil section 410 or the sleeve 400. This would not significantly interfere with the heat transferred to the aerosol generating article but would improve the structural stability of the coil structure.

A second coil structure, marked as coil structure B, comprises a sleeve 500 similar to coil structure A including a helical coil section 510 obtained by material removal. Sleeve 500 comprises a downstream extended portion 550 which is used to couple the sleeve within the housing 12 of the chamber 16 of the aerosol-generating device. Extended portion 550 comprises through-holes 520 to allow airflow through the sleeve and into the aerosol generating article.

A third coil structure, coil structure C, comprises a sleeve 600 with a helical coil section 610 and a downstream extended region 650, which comprises through-holes 620 which are greater in size and in number than for the through-holes 520 of coil structure B. When compared to coil structure B, bigger openings 620 offer the advantage of reducing the mass of the structure and therefore significantly mitigates heat losses caused by heat conduction towards end regions of the sleeve.

Although the devices described so far all use helical shaped coils, it is possible to use other forms of inductor coil. In particular, one or more flat spiral coils or pancake coils could be used to both generate an alternating magnetic field within the chamber 16 and to provide for external heating from resistive heating of the coil itself. Such flat spiral coils could be shaped to conform to the side wall of the chamber and arranged to generate a magnetic field orthogonal to a longitudinal axis of the chamber. Where the inductor coil is intended to be in surface contact with an exterior surface of the aerosol-generating article, the use of a coil having a flat cross-sectional profile may facilitate conduction between the coil and the article of heat generated by resistive heating of the coil

FIG. 7 shows a cross-sectional view of an aerosol-generating device 250 according to a third embodiment. The aerosol-generating device 250 is similar to the aerosol-generating device 150 described with reference to FIGS. 4 and 5 and like reference numerals are used to designate like parts.

The embodiment of FIG. 7 differs from the embodiment of FIGS. 4 and 5 in the position of the inductor coil 224 and in the provision of a thermal bridging element 228 between the coil 224 and the aerosol generating article 172. The inductor coil 224 is embedded or recessed within the housing of the device 250, and the thermal bridging element 228 formed from a thermally conductive material is placed in contact with the inductor coil 224. The thermal bridging element 228 is in the form of an austenitic steel tube. The thermal bridging element 228 partially defines a cylindrical wall of the chamber that extends between the open end and the closed end of the chamber. The thermal bridging element 228 is arranged so that an aerosol-generating article 172 is received within the thermal bridging element 228 and in direct contact with the thermal bridging element 228 when the aerosol-generating article is inserted into the chamber. Advantageously, direct contact between the thermal bridging element 228 and an aerosol-generating article 172 facilitates the transfer of heat from the thermal bridging element 228 to the aerosol-generating article.

The inductor coil 224 comprises a plurality of windings that extend around an outer surface of the thermal bridging element 228. The inductor coil 224 is arranged so that the plurality of windings are in direct contact with the outer surface of the thermal bridging element 228. Advantageously, positioning the inductor coil 224 in direct contact with an outer surface of the thermal bridging element 228 facilitates the transfer of heat generated by resistive heating of the inductor coil 224 to the thermal bridging element 228. The inductor coil 224 and the thermal bridging element 228 are arranged concentrically about a central axis of the aerosol-generating device 250.

The control of the devices described in FIGS. 1 to 7 will now be explained in detail.

FIG. 8 is a block diagram illustrating an exemplary configuration of components and circuitry for generating and providing an alternating current to an inductor coil of an aerosol-generating device, such as the inductor coil 24 of the aerosol-generating devices 10, 150 of FIGS. 1 and 4. A DC power source 310 is coupled to an inductive heating arrangement 320. The heating arrangement 320 comprises a controller 330, a DC/AC converter 340, a matching network 350 and an inductor coil 240. The DC power source 310 of FIG. 8 corresponds to or forms part of the power supply 42 of the aerosol-generating devices 10, 150 of FIGS. 1 and 4. The controller 330, DC/AC converter 340 and matching network 350 correspond to or form part of the control circuitry 40 of the aerosol-generating devices 10, 150 of FIGS. 1 and 4. The inductor coil 240 corresponds to the inductor coil 24 of the aerosol-generating devices 10, 150 of FIGS. 1 and 4. The DC power source 310 is configured to provide DC power to the heating arrangement 320. Specifically, the DC power source 310 is configured to provide a DC supply voltage (V_{DC}) and a DC current (I_{DC}) to the DC/AC converter 340. Preferably, the power source 310 is a battery, such as a lithium ion battery. As an alternative, the power source 310 may be another form of charge storage device, such as a capacitor. The power source 310 may require recharging. For example, the power source 310 may have sufficient capacity to allow for the continuous generation of aerosol for a period of around six minutes or for a period that is a multiple of six minutes. In another example, the power source 310 may have sufficient capacity to allow for a predetermined number of puffs or discrete activations of the heating arrangement.

The DC/AC converter 340 is configured to supply the inductor coil 240 with a high frequency alternating current. As used herein, the term “high frequency alternating current” means an alternating current having a frequency of between about 500 kilohertz and about 30 megahertz. The high frequency alternating current may have a frequency of between about 1 megahertz and about 30 megahertz, such as between about 1 megahertz and about 10 megahertz, or such as between about 5 megahertz and about 8 megahertz.

FIG. 9A schematically illustrates a first embodiment of electrical circuitry for use in supplying the inductor coil 240 with electric energy. The DC/AC converter 340 preferably comprises a Class-E power amplifier. The Class-E power amplifier comprises a transistor switch 1320 comprising a Field Effect Transistor 1321, for example a Metal-Oxide-Semiconductor Field Effect Transistor, a transistor switch supply circuit indicated by the arrow 1322 for supplying a switching signal (gate-source voltage) to the Field Effect Transistor 1321, and an LC load network 1323 comprising a shunt capacitor C1 and a series connection of a capacitor C2 and inductor coil L2. Inductor coil L2 corresponds to inductor coil 240 of FIG. 8. In addition, DC power source 11, comprising a choke inductor L1, is shown for supplying the DC supply voltage V_{DC}, with the DC current I_{DC} being drawn from the DC power source 11 during operation. The ohmic resistance R represents the total ohmic load 1324, which is the sum of the ohmic resistance R_{coil} of the inductor coil L2 and the ohmic resistance R_{load} of the susceptor element. The DC power source 11 corresponds to the DC power source 310 of FIG. 8.

The transistor switch supply circuit 1322 may supply a switching voltage having a rectangular profile to the Field Effect Transistor 1321. As long as the Field Effect Transistor 1321 is conducting (in an “on”-state), it essentially constitutes a short circuit (low resistance) so that the entire current flows through the choke L₁ and the Field Effect Transistor 1321. When the Field Effect Transistor 1321 is non-conducting (in an “off”-state), the entire current flows into the LC load network 1323 since the Field Effect Transistor 1321 essentially represents an open circuit (high resistance). Switching the Field Effect Transistor 1321 between conducting (“on”) and non-conducting (“off”) states inverts the supplied DC voltage V_{DC} and DC current I_{DC} into an AC voltage V_{AC} and AC current I_{AC} flowing in the inductor coil L2, having frequency f.

In an alternative mode of operation, the transistor switch supply circuit 1322 is inactive so that the supplied DC current I_{DC} is not converted to AC current, but remains as direct current.

So, the circuit of FIG. 9A allows for supply to the inductor coil L2 of one of AC current lac or DC current I_{DC}, but not both lac and I_{DC} simultaneously.

FIG. 9B schematically illustrates a second embodiment of electrical circuitry for use in supplying the inductor coil 240 with electric energy. The circuitry of FIG. 9B includes all of the components of the circuitry of FIG. 9A, but includes additional circuitry. The additional circuitry is discussed below.

A DC feed to the inductor coil L2 is provided. A DC power supply DC_{S} is connected to the inductor coil L2 through a transistor switch 1326. An additional choke inductor L3 is arranged between DC power supply DC_{S} and the capacitor C2.

The transistor switch 1326 is driven by a transistor switch supply circuit indicated by the arrow 1325 for supplying the switching signal (gate-source voltage). The DC source DC_{S} could be a battery or in general any means capable of producing a DC current. In particular, the battery could be the same power source as the one generating the DC voltage V_{DC} for feeding to the DC/AC converter 340 in order to generate the AC current lac. When the switch 1326 is activated, a DC current I_{DC2} will flow through inductors L3 and L2.

Choke inductor L3 has the specific purpose of preventing the AC current lac from flowing through the DC source DC_{S}. For this purpose, advantageously, the inductance value of L3 is significantly higher than the inductance of inductor coil L2. Similarly, choke inductor L1 does not allow AC current to flow within DC source V_{DC}.

The circuit of FIG. 9B allows the simultaneous or alternate flow of a) AC current I_{AC} (generated by V_{DC}) flowing through capacitor C2, inductor coil L2 and capacitor C1, and b) direct current I_{DC2} through inductor L3 and inductor coil L2. Direct current I_{DC2} does not reach choke inductor L1 because of the presence of capacitor C2, which is seen by I_{DC2} as an open circuit.

The circuit could also operate without the choke inductor L3, as long as the circuit is set up for operating sequentially with AC current and DC current (that is AC and DC are not to be activated simultaneously).

As explained in detail below, it is also possible to resistively heat the inductor coil L2 by the AC current lac if the frequency of that current is such that there is little coupling to the susceptor element. It could also be advantageous to add a capacitor C3 in parallel to inductor coil L2. In this way, inductor coil L2 is more frequency selective. As explained below, the presence of capacitor C3 may greatly improve the process of switching from a frequency f_{susceptor} to a frequency f_{inductor coil} to change from internal to external heating as a result of AC current, since the difference between the two frequency values may be significantly reduced. In this way, the control may run smoother. Without capacitor C3, the two frequency values may be distant from each other, making the system slower to react.

Although the DC/AC converter 340 is illustrated as comprising a Class-E power amplifier, the DC/AC converter 340 may use any suitable circuitry that converts DC current to AC current. For example, the DC/AC converter 340 may comprise a class-D power amplifier comprising two transistor switches. As another example, the DC/AC converter 340 may comprise a full bridge power inverter with four switching transistors acting in pairs.

Turning back to FIG. 8, the inductor coil 240 may receive the alternating current from the DC/AC converter 340 via the matching network 350 for optimum adaptation to the load, but the matching network 350 is not essential. The matching network 350 may comprise a small matching transformer. The matching network 350 may improve power transfer efficiency between the DC/AC converter 340 and the inductor coil 240.

As illustrated in FIGS. 1 and 4, the inductor coil 24 is located around the chamber 16 of the aerosol-generating device 10, 150. Accordingly, the high frequency alternating current lac supplied to the inductor coil 24 during operation of the aerosol-generating device 10, 150 causes the inductor coil to generate a high frequency alternating magnetic field within the chamber 16 of the aerosol-generating device 10, 150. The alternating magnetic field preferably has a frequency of between 1 and 30 megahertz, preferably between 2 and 10 megahertz, for example between 5 and 7 megahertz. As can be seen from FIGS. 3 and 5, when an aerosol-generating article 102, 172 is inserted into the chamber 16, the aerosol-forming substrate 104 of the aerosol-generating article is located adjacent to the inductor coil 24 so that the susceptor element 114, 164 is located within this alternating magnetic field. When the alternating magnetic field penetrates the susceptor element 114, 164, the alternating magnetic field causes heating of the susceptor element. For example, eddy currents are generated in the susceptor element 114, 164, which is heated as a result. Further heating is provided by magnetic hysteresis losses within the susceptor element 114, 164.

Similarly when the inductor coil 24 itself is resistively heated by the DC current I_{DC2} (and/or by the AC current I_{AC}), heat is transferred to the aerosol-generating article 102, 172 located adjacent to the inductor coil 24.

The heated susceptor element 114, 164 and/or the heated inductor coil 24 heats the aerosol-forming substrate 104 of the aerosol-generating article 102, 172 to a sufficient temperature to form an aerosol. The aerosol is drawn downstream through the aerosol-generating article 102, 172 and inhaled by the user.

The controller 330 may be a microcontroller, preferably a programmable microcontroller. The controller 330 is programmed to regulate the supply of power from the DC power source 310 to the inductive heating arrangement 320 in order to control the temperature of the susceptor element.

FIG. 10 illustrates one possible scheme for supplying current to the inductor coil 24, 240. The scheme of FIG. 10 could be implemented using the electrical circuitry of FIG. 9A. For the scheme shown in FIG. 10, AC current lac alone is supplied to the inductor coil 24, 240, with the frequency of the AC current lac changed from a first frequency f1 to a second frequency f2. In the embodiment shown in FIG. 10, frequencies f1 and f2 act over respective first and second time intervals. Frequencies f1 and f2 provide differing levels of inductive coupling between the inductor coil 24, 240 and susceptor element 114, 164. Explaining further, frequency f1 corresponds to a frequency f_{inductor coil}, in which the AC current lac creates a magnetic field that provides little to no coupling with the susceptor element 114, 164 and allows almost the totality of the energy in the supplied current to remain within the inductor coil 24, 240, resulting in most of the heat being generated by resistance heating of the inductor coil. So, the application of AC current lac of frequency f1 over the first time interval results in the aerosol-forming substrate 104 being predominantly heated externally of the substrate 104, through resistance heating of the inductor coil 24, 240. Frequency f2 corresponds a frequency f_{susceptor}, in which the AC current lac creates a varying magnetic field that best couples with the susceptor element 114, 164, so as to allow transfer of almost the totality of the energy to the susceptor element, resulting in most of the heat being generated by heating of the susceptor element. So, the application of AC current I_{AC} of frequency f2 over the second time interval results in the aerosol-forming substrate 104 being predominantly heated from within, through heating of the susceptor element 114, 164. So, the frequencies f1, f2 correspond to different heating modes or phases for the aerosol-generating device 10, 150. Alternatively, frequency f1 or f2 may correspond to a frequency fₜₒₜₐₗ, in which the AC current lac results in a simultaneous combination of heating of the susceptor element 114, 164 and resistance heating of the inductor coil 24, 240, thereby heating the aerosol-forming substrate 104 both internally and externally.

FIG. 11 illustrates another possible scheme for supplying current to the inductor coil 24, 240. In the scheme shown in FIG. 11, AC current lac is supplied at different times to DC current I_{DC}. The scheme of FIG. 11 could be implemented using the electrical circuitry of FIG. 9B. The top graph shows the AC current lac and the bottom graph shows the DC current I_{DC}. This scheme requires the controller 330 to operate transistor switches 1320 and 1326 (shown in FIG. 9B) alternately. With this scheme, heat may be transferred to the aerosol-forming substrate 104 from an internal source (through heating of the susceptor element 114, 164) and then from an external source (through heating of the inductor coil 24, 240) alternately. However, as indicated in the discussion of the scheme of FIG. 10, the degree of internal heating provided via the susceptor element 114, 164 will be dependent on the frequency of the AC current lac and the associated level of inductive coupling between the inductor coil 24, 240 and the susceptor element 114, 164.

FIG. 12 illustrates another possible scheme for supplying current to the inductor coil 24, 240. The scheme of FIG. 12 could be implemented using the electrical circuitry of FIG. 9B. In the scheme shown in FIG. 12, in a first phase AC current I_{AC} is supplied with a first frequency f1′ and no DC current is supplied. Frequency f1′ is chosen to maximise inductive coupling to the susceptor element 114, 164 and so maximise heating of the susceptor element. In a second phase AC current lac is supplied with a second frequency f2′ and DC current I_{DC} is also supplied simultaneously with lac. Frequency f2′ is chosen to reduce inductive coupling to the susceptor 114, 164 compared to frequency f1′ and so to provide greater heating of the inductor coil 24, 240 itself. The DC current I_{DC} also contributes to resistive heating of the inductor coil 24, 240. So, in the first phase the aerosol-forming substrate 104 is internally heated by the susceptor element 114, 164 and in the second phase the aerosol-forming substrate is externally heated by the inductor coil 24, 240.

FIG. 13 illustrates another possible scheme for supplying current to the inductor coil 24, 240. The scheme of FIG. 13 could be implemented using the electrical circuitry of FIG. 9A. In common with the scheme of FIG. 10, AC current lac alone is supplied to the inductor coil 24, 240, with the frequency of the AC current lac changed between a first frequency f1 and a second frequency f2. When no puff is detected as being applied to the aerosol-generating article 102, 172, the AC current lac having frequency f1 is supplied to the inductor coil 24, 240. However, upon detection of an applied puff by the control circuitry 40, the frequency of the AC current lac is switched to frequency f2, with frequency f2 maintained over the duration of the applied puff. Once a user has ceased applying a given puff, the frequency of the alternating current lac reverts back to frequency f1. FIG. 13 shows how the AC current frequency lac alternates between f1 and f2 depending on whether or not a puff is being applied. The aerosol-generating device 10, 150 may include a pressure sensor or temperature sensor to assist in the detection of an applied puff. It will also be appreciated that the inductor coil 24, 240 and susceptor element 114, 164 may indirectly function as a means of determining changes in temperature. The frequencies f1 and f2 may correspond to those of the scheme shown in FIG. 10. So, frequency f1 may correspond to a frequency f_{inductor coil}, in which the AC current lac creates a magnetic field that provides little to no coupling with the susceptor element 114, 164 and allows almost the totality of the energy in the supplied current to remain within the inductor coil 24, 240, resulting in most of the heat being generated by resistance heating of the inductor coil. So, the application of AC current I_{AC} of frequency f1 when no puff is detected results in the aerosol-forming substrate 104 being predominantly heated externally, through resistance heating of the inductor coil 24, 240. Frequency f2 corresponds a frequency f_{susceptor}, in which the AC current lac creates a varying magnetic field that best couples with the susceptor element 114, 164, so as to allow transfer of almost the totality of the energy to the susceptor element, resulting in most of the heat being generated by heating of the susceptor element. So, the application of AC current LAC of frequency f2 over the duration of an applied puff results in the aerosol-forming substrate 104 being predominantly heated from within, through heating of the susceptor element 114, 164.

FIG. 14 illustrates another possible scheme for supplying current to the inductor coil 24, 240. The scheme of FIG. 14 could be implemented using the electrical circuitry of FIG. 9A. The scheme of FIG. 14 is a variation of the scheme of FIG. 13. In common with the scheme of FIG. 13, the frequency of the AC current lac alternates between first frequency f1 (corresponding to when no puff is applied to the aerosol-generating article 102, 172) and second frequency f2 (corresponding to when a puff is detected as having been applied to the aerosol-generating article). However, when application of a puff is detected, the magnitude of the AC current lac is also increased relative to the magnitude of the AC current employed when no puff is detected. The AC current lac of increased magnitude and frequency f2 is maintained over the duration of the applied puff, before reverting to frequency f1 and a reduced magnitude upon ceasing of the applied puff. As stated above for FIG. 13, frequency f2 corresponds a frequency f_{susceptor}, in which the AC current lac creates a varying magnetic field that best couples with the susceptor element 114, 164, so as to allow transfer of almost the totality of the energy in the supplied current to the susceptor element, resulting in most of the heat being generated by heating of the susceptor element. The increase in magnitude of the AC current lac when a puff is being applied enhances heating of the susceptor element 114, 164 compared to retaining the AC current at the same magnitude for frequencies f1 (no puff applied), f2 (puff being applied).

Of course there are any number of possible schemes for supplying AC and DC currents to the inductor coil 24, 240 to provide the desired combination of internal and external heating of the aerosol-forming substrate 104 over time. As discussed above, the frequency of the AC current can be chosen to provide a desired balance between heating of the susceptor element and heating of the coil. The control circuitry 40 can be configured to control the switches 1320 and 1326 to follow a particular profile of internal and external heating over time.

FIG. 15 illustrates one possible scheme with a target temperature profile for the susceptor element 114, 164 shown in dotted line 800 and a target temperature profile for the inductor coil 24, 240 shown by the solid line 810. In an initial phase, no DC current is supplied and the frequency of the AC current is chosen for maximum heating of the susceptor element 114, 164. This is to provide for rapid internal heating of the aerosol-forming substrate 104. This assists in minimising the delay between activating the aerosol-generating device and producing aerosol for the user.

After the initial phase, the target temperature for the susceptor element 114, 164 is reduced. The magnitude of the AC current is therefore reduced. At this point the temperature of the aerosol-forming substrate 104 has been significantly raised by heat transfer from the susceptor element 114, 164 and reducing the susceptor element temperature avoids overheating of the aerosol-forming substrate, which might lead to undesirable compounds in the aerosol. However, at this point a target temperature of the inductor coil 24, 240 is stepped up. DC current is supplied to the inductor coil 24, 240 to raise the temperature of the inductor coil and begin external heating of the aerosol-forming substrate 104.

As the usage session of the system progresses, the target temperature of the inductor coil 810 is raised, stepwise, until it is close to or the same as the target temperature of the susceptor element 800. This ensures that the outer regions of the aerosol-forming substrate 104 are fully depleted by the end of the usage session.

The target temperature profiles shown in FIG. 15 are just one example. The target temperature profiles can be arranged in any desired manner and need not have stepwise changes but instead may continuously vary. As described, the temperature of the inductor coil 24, 240 may be raised by AC currents of appropriate frequency as well as by a DC current.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number “A” is understood as “A”±10% of “A”. Within this context, a number “A” may be considered to include numerical values that are within general standard error for the measurement of the property that the number “A” modifies. The number “A”, in some instances as used in the appended claims, may deviate by the percentages enumerated above provided that the amount by which “A” deviates does not materially affect the basic and novel characteristic(s) of the claimed invention. Also, all ranges include the maximum and minimum points disclosed and include any intermediate ranges therein, which may or may not be specifically enumerated herein.

1.-15. (canceled)

16. An aerosol-generating system for generating an aerosol from an aerosol-forming substrate of an aerosol-generating article, the aerosol-generating system comprising:
control electronics; and
an electric heating arrangement comprising an inductor coil and a susceptor, the susceptor positioned or positionable such that the susceptor is at least partially within the inductor coil;
wherein the control electronics are configured to:
supply electric energy from a power source to the inductor coil as an alternating current such that the electric heating arrangement is operable to generate heat through one or a combination of i) resistance heating of the inductor coil and ii) heating of the susceptor through inductive coupling of the inductor coil with the susceptor, and
apply the alternating current to the inductor coil over successive first and second phases of operation and adjust a frequency of the alternating current so as to change inductive coupling of the inductor coil with the susceptor between the successive first and second phases of operation, thereby adjusting a balance of heat generated through the inductive coupling of the inductor coil with the susceptor relative to heat generated through resistance heating of the inductor coil.

17. The aerosol-generating system according to claim 16, wherein the control electronics are further configured to adjust a magnitude of the alternating current so as to change the inductive coupling of the inductor coil with the susceptor between the successive first and second phases of operation.

18. The aerosol-generating system according to claim 17,
wherein the control electronics are further configured to adjust the frequency of the alternating current from a first frequency value or range of values to a second frequency value or range of values, the first frequency value or range of values corresponding to a first heating state of the electric heating arrangement and the second frequency value or range of values corresponding to a second heating state of the electric heating arrangement, and
wherein the second frequency value or range of values is closer than the first frequency value or range of values to a resonant frequency of the electric heating arrangement, such that the inductive coupling of the inductor coil with the susceptor is increased in the second heating state compared to the first heating state.

19. The aerosol-generating system according to claim 18, wherein the control electronics are further configured to trigger adjustment of the frequency of the alternating current between the first and the second values or range of values as a function of one or more of:
a) a puff count over a usage session,
b) time elapsed since commencement of a usage session, and
c) detection of a puff in a usage session.

20. The aerosol-generating system according to claim 19, wherein the control electronics are further configured to adjust the frequency of the alternating current from the first frequency value or range of values to the second frequency value or range of values in response to receiving a signal indicative of a puff being applied to the aerosol-generating system.

21. The aerosol-generating system according to claim 20,
wherein the control electronics are further configured to maintain the frequency of the alternating current at the second frequency value or range of values for a predetermined period of time after receiving the signal indicative of a puff being applied to the aerosol-generating system, and
wherein the control electronics are further configured to, after elapse of the predetermined period of time, adjust the frequency of the alternating current from the second frequency value or range of values to a third frequency value or range of values, the third frequency value or range of values corresponding to a third heating state of the electric heating arrangement, the third frequency value or range of values being farther away than the second frequency value or range of values from the resonant frequency of the electric heating arrangement, such that the inductive coupling of the inductor coil with the susceptor is reduced in the third heating state compared to the second heating state.

22. The aerosol-generating system according to claim 16, wherein the wherein the control electronics are further configured to supply electric energy from a power source to the inductor coil as a direct current.

23. The aerosol-generating system according to claim 22, wherein the control electronics are further configured to switch between one or more of the following operational states:
a first operational state in which the inductor coil is supplied with alternating current alone,
a second operational state in which the inductor coil is supplied with direct current alone, and
a third operational state in which the inductor coil is supplied with both alternating current and direct current.

24. The aerosol-generating system according to claim 16,
wherein the inductor coil is formed in an electrically conductive tubular member, and
wherein one or more cut-outs are provided in the tubular member to thereby define the shape and configuration of the inductor coil.

25. The aerosol-generating system according to claim 16,
further comprising an aerosol-generating device,
the aerosol-generating device comprising the inductor coil, the susceptor, and a chamber,
the inductor coil surrounding or at least partially defining a peripheral wall of the chamber, and
the susceptor being arranged within the chamber,
wherein the chamber is configured to receive the aerosol-generating article comprising the aerosol-forming substrate such that the susceptor inserts within the aerosol-generating article.

26. The aerosol-generating system according to claim 16,
further comprising an aerosol-generating device and the aerosol-generating article,
the aerosol-generating device comprising the inductor coil and a chamber,
the inductor coil surrounding or at least partially defining a peripheral wall of the chamber, and
the aerosol-generating article comprising the aerosol-forming substrate and the susceptor, the susceptor being enclosed by or at least partially embedded within the aerosol-forming substrate,
wherein the chamber is configured to receive the aerosol-generating article such that the susceptor is positioned at least partially within the inductor coil.

27. The aerosol-generating system according to claim 25, wherein the inductor coil is configured to be in surface contact with an exterior surface of the aerosol-generating article upon the aerosol-generating article being received in the chamber.

28. The aerosol-generating system according to claim 25, further comprising a thermally conductive bridging element configured to extend between the inductor coil and an exterior surface of the aerosol-generating article when the aerosol-generating article is received in the chamber of the aerosol-generating device.

29. A method of heating an aerosol-forming substrate of an aerosol-generating article, the method comprising:
providing an electric heating arrangement comprising an inductor coil and a susceptor, the susceptor enclosed by or at least partially embedded within the aerosol-forming substrate, the susceptor at least partially within the inductor coil;
controlling a supply of electric energy from a power source to the inductor coil as an alternating current over successive first and second phases of operation such that the electric heating arrangement generates heat through one or a combination of i) resistance heating of the inductor coil and ii) heating of the susceptor through inductive coupling of the inductor coil with the susceptor; and
adjusting a frequency of the alternating current so as to change the inductive coupling of the inductor coil with the susceptor between the successive first and second phases of operation, thereby adjusting a balance of heat generated through inductive coupling of the inductor coil with the susceptor relative to heat generated through resistance heating of the inductor coil.

30. The method according to claim 29, wherein the adjusting step further comprises adjusting a magnitude of the alternating current.

31. The method according to claim 29, further comprising:
adjusting the frequency of the alternating current from a first frequency value or range of values to a second frequency value or range of values, the first frequency value or range of values corresponding to a first heating state of the electric heating arrangement and the second frequency value or range of values corresponding to a second heating state of the electric heating arrangement, the second frequency value or range of values being closer than the first frequency value or range of values to a resonant frequency of the electric heating arrangement, such that the inductive coupling of the inductor coil with the susceptor is increased in the second heating state compared to the first heating state.
